(19) United States
(12) Patent Application Publication
(10) Pub. No.: US 2017/0080877 A1
(43) Pub. Date: Mar. 23, 2017

(54) Vented Detachable Phone Holder for Automobiles

(71) Applicant: Akiva E. Boas, Brooklyn, NY (US)

(72) Inventor: Akiva E. Boas, Brooklyn, NY (US)

(21) Appl. No.: 15/260,001

(22) Filed: Sep. 8, 2016

Related U.S. Application Data
(60) Provisional application No. 62/221,738, filed on Sep. 22, 2015.

(51) Int. Cl. B60R 11/02; B60H 1/34; B60H 1/00

(52) U.S. Cl. CPC B60R 11/0241; B60H 1/00264; B60H 1/3428; B60R 2011/0008

(57) ABSTRACT

The invention provides an automotive detachable holder for devices such as cellular phones. The holder can be attached to an air vent in a vehicle, permits adjustment of the position and orientation of the device, and is equipped with passages and vents that allow the air flowing from the vent to be directed in a desired direction. The invention is an improvement over prior art holders that block and/or misdirect the air flow from the vent to which they are attached.

### RELATED APPLICATIONS

This application claims priority to U.S. provisional application No. 62/221,738, filed on Sep. 22, 2015, the contents of which are hereby incorporated by reference in their entirety.

### FIELD OF THE INVENTION

The present invention relates to clip on phone holders. In particular, the present invention relates to a vent attachable detachable phone holder that allows for multi-directional air flow control in automobiles.

### BACKGROUND OF THE INVENTION

Modern automobiles use electronic systems to provide a comfortable environment for drivers and passengers alike. Temperature is generally controlled through the use of heating and air conditioning components. These are powered through the use of fans running at various speeds to create air circulation. Proper air circulation is imperative to ensure a vehicles climate control functions properly and provides a comfortable environment for those within.

It has become common for vehicle owners to install clip-on holders that attach to the louvers of a vent within the vehicle cabin. Typical devices include but are not limited to air fresheners, cup holders, and phone holders. The problem with these devices, and in particular the larger ones, is that they block a substantial amount of the air flow coming out of the vent to which they are attached. Also, the vent's louvers are generally immobilized; furthermore, any air that is able to come out of the vent is likely to be re-directed in an undesirable direction by the holder, which obstructs the desired air flow. There is a need for detachable clip-on holders that do not block or re-direct air flow from the vent to which they are mounted.

A further disadvantage of prior art clip-on holders is that, when they are used to hold electronic devices such as mobile phones, tablets and navigational devices, hot air emerging from the vent in cold weather usually impinges directly on the device. This can cause overheating that may damage the device, or cause thermal protection circuits to shut down the device. In hot, humid weather, cold air from the air conditioner chills the device, which then becomes vulnerable to damage from condensation when it is removed to the outside air. There is a need for clip-on holders that do not expose electronic devices to such overheating or chilling.

It is therefore an objective of the present invention to provide a vent-attachable holder for vehicles that allows for control of the flow rate and flow direction of the vent's output. The devices of the invention utilize a unique arrangement of components including one or more openings that become extensions of the vent to which they are attached.

### BRIEF DESCRIPTION OF THE INVENTION

Broadly described, the invention provides a detachable holder for objects to be held in place in a vehicle. The holder comprises a means for attaching the holder to a louver of an air vent in the vehicle, to which is attached, via a multi-axis rotatable joint, a substantially hollow body having at least one air exit vent. A bellows capable of substantially or completely covering the air vent is rotatably connected to the body by a cylindrical connector. A clamp capable of holding the object to be held is also rotatably attached to the hollow body. An air passage between the bellows and the body permits air from the vehicle's vent to by-pass the clamp and the object held therein, and emerge from the exit vent(s) of the hollow body.

### BRIEF DESCRIPTION OF THE DRAWINGS

FIG. 1 is a perspective front view of one embodiment of the present invention.

FIG. 2 is a perspective rear view of one embodiment of the present invention.

FIG. 3 is a rear view of the same embodiment of the present invention.

FIG. 4 is a top view of the same embodiment of the present invention.

FIG. 5 is a side view of the same embodiment of the present invention.

FIG. 6 shows a cross-sectional view through FIG. 1 on the line shown.

### DETAILED DESCRIPTION OF THE INVENTION

In view of the aforementioned problems, the present invention is a vent-attachable detachable holder that allows for multi-directional air flow control in a truck, automobile, or other vehicle. The holder utilizes a unique arrangement of components including at least one air exit vent that becomes an extension of the vehicle's air vent. Before explaining the exemplified embodiment of the present invention in detail, it is to be understood that the invention is not limited in its application to the details of the components and arrangements as described or illustrated. The invention is capable of other embodiments and of being utilized and carried out in various ways. It is also to be understood that the phrasing and terminology employed herein are for the purpose of description and should not be regarded as limiting.

As such, the present invention is primarily used as an attachment to a vent inside the cabin of a vehicle, but the holder may be applied to other settings, scenarios, and environments. The particular embodiment described in detail herein is intended for use as a mobile phone holder, but holders for other devices and objects, including but not limited to maps, navigation devices, and beverages, are contemplated to be within the scope of the invention.

As noted above, the invention provides a detachable holder for objects to be held in place in a vehicle, comprising: (a) means for attaching the holder to a louver of an air vent in the vehicle; (b) a substantially hollow body, linked to the clip by a multi-axis rotatable joint and having one or more air exit vents; (c) a bellows rotatably attached to the substantially hollow body and capable of substantially or completely covering the vehicle's air vent; and (d) a clamp capable of holding the object to be held, rotatably attached to the substantially hollow body. An air passage is present between the bellows and the body, enabling air from the vehicle's air vent to pass into the body and to exit the body through the air exit vent(s).

The means for attaching the holder to a louver may be one or more clips, having jaws capable of gripping a louver of an air vent in the vehicle. Alternatively, the means for attaching the holder to a louver may be one or more spikes that are driven between adjacent louvers. The means for attaching the holder to a louver may also be one or more slotted gripping devices, wherein a louver is driven into the slot to effect the attachment. Equivalent devices will be apparent to those of skill in the art, and are intended to fall within the scope of this description. The means for attaching the holder to a louver may be any combination of one or more of the aforementioned structures.

In a preferred embodiment, the multi-axis rotatable joint is a ball-and-socket joint. The bellows is preferably connected to the body by nested cylindrical connectors. The nested cylindrical connectors define a cylindrical space, serves as the air passage between the bellows and the body. In certain embodiments, the multi-axis rotatable joint projects through this cylindrical space. The rotatable joint preferably lies on the axis of the cylindrical space. In particularly preferred embodiments, the body has two air exit vents.

Attention is now brought to the accompanying drawings. It will be understood that the Figures in the drawings are presented solely for the purpose of illustrating selected embodiments of the present invention, and are not intended to limit the scope of the invention.

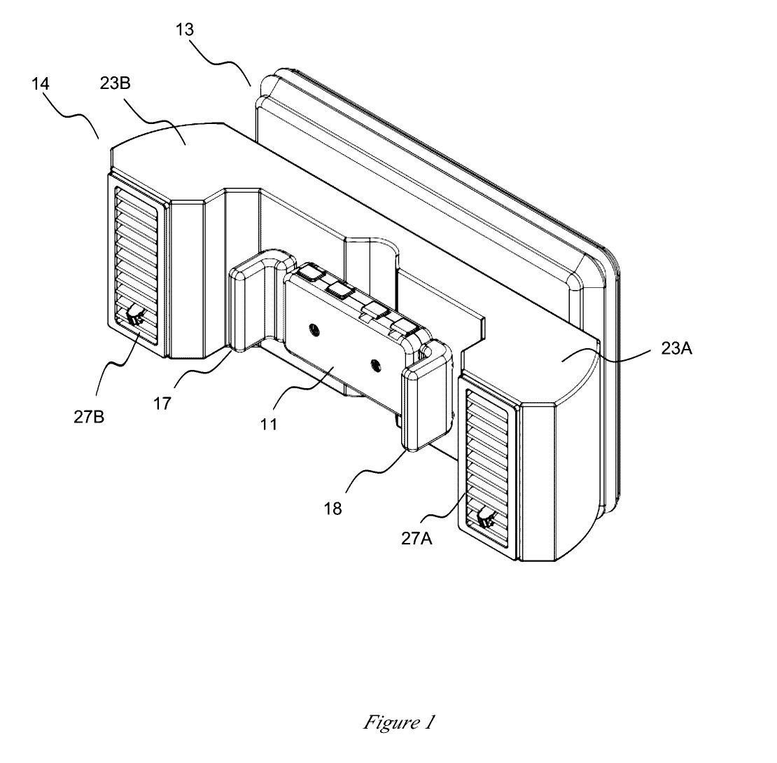

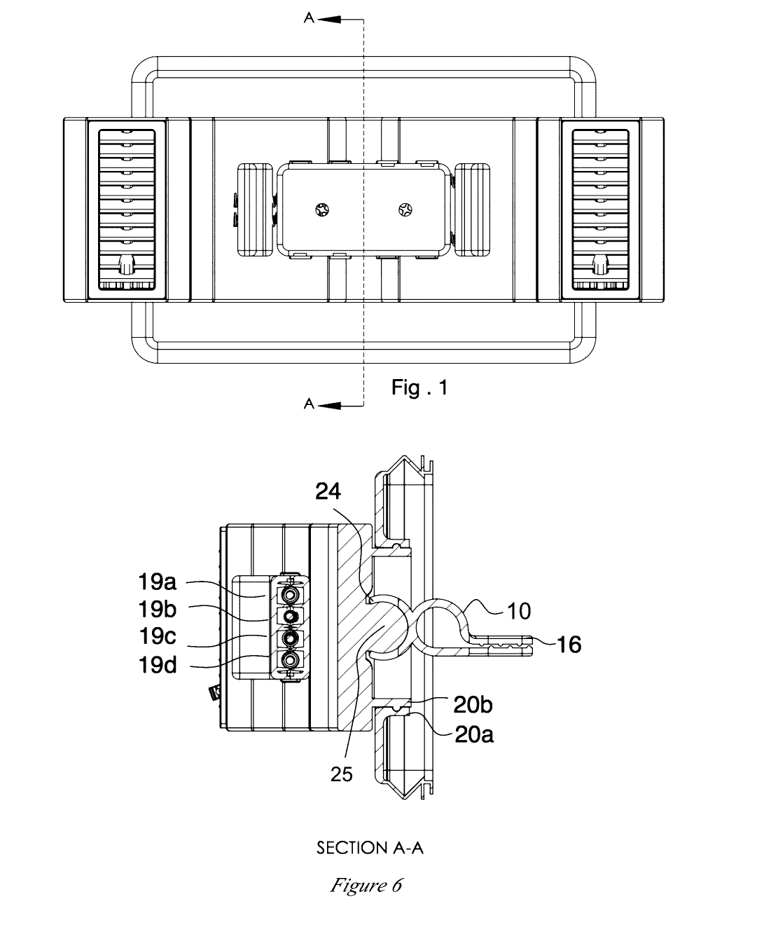

FIG. 1 is a perspective view, from the front side, of a particular embodiment of the present invention. Clamp 11 is centrally located on the front face of the base 14. In the particular embodiment illustrated in the drawings, the clamp 11 comprises a first finger 17, a second finger 18, and springs 19a-19d (not shown; see FIG. 6) that bias the fingers toward each other, making it suitable for holding a cell phone, but the clamp may be any type of clamp suitable for immobilizing whatever device or object the practitioner desires to hold in place, as are known in the art. By way of example, the clamp may be a cup holder, or a holder suitable for a tablet, book, navigational device, clipboard, or map.

The clamp may be directly affixed to front face of the base 14, as shown in FIG. 1, or it may be a removable piece. Clamp 11 may optionally be attached to base 14 via a rotatable or multi-axis joint. In a preferred embodiment of the present invention, clamp 11 is used to physically grasp a cellular phone. The clamp in the illustrated embodiment comprises two spring-loaded symmetric pieces, finger 17 and finger 18. The springs bias fingers 17 and 18 towards each other. With this embodiment, the user applies tension to either finger 17, finger 18, or both, in order to separate the fingers and insert a phone (or other object to be held) between the fingers. Upon releasing the tension, the springs pull the fingers together, securely holding the phone in place.

Base 14 is a substantially hollow shell, and comprises first and second duct portions 23A and 23B disposed on either side of clamp 11. The interior of first duct portion 23A defines a first air channel (not shown), which terminates in a vent with preferably adjustable louvers 27A. Second duct potion 23B similarly defines a second air channel, which terminates in a second vent with louvers 27B. Louvers 27A and 27B are used to direct the emergent air flow in a desired direction. Attached to the rear of base 14 is the bellows 13. Bellows 13 is a substantially hollow structure, capable of substantially or completely covering a vehicle's air vent, which directs air from the vehicle vent into the interior of base 14.

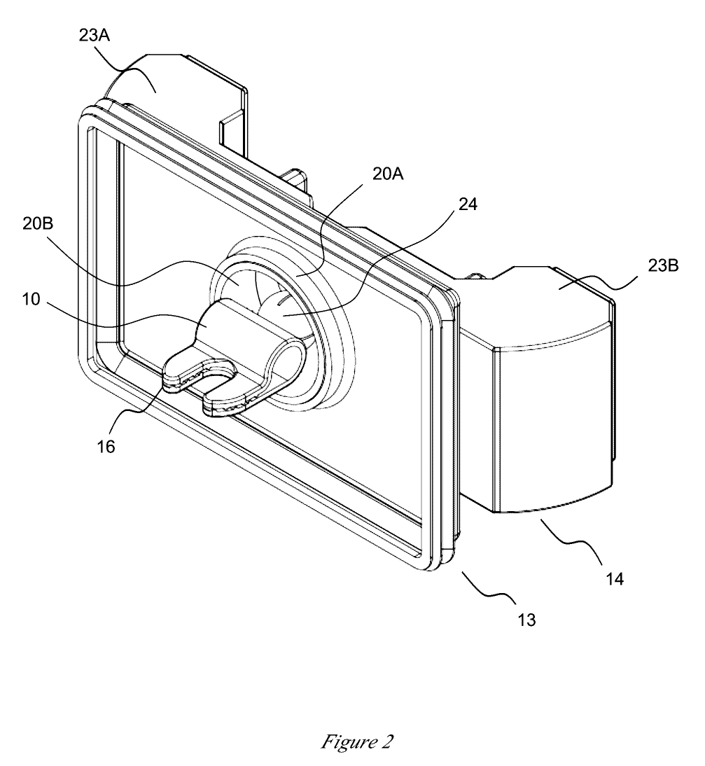

FIG. 2 is a perspective view, from the rear side, of a particular embodiment of the present invention. Substantially centered on the interior surface of bellows 13, and attached thereto, is a first component 20A of a rotatable connector assembly. Component 20A is a cylindrical structure within which a second component 20B of the rotatable connector assembly is nested. Second component 20B is attached to base 14. The components 20A and 20B are preferably, as illustrated in the drawings, nesting cylindrical components that snap together, thereby attaching the base 14 to the bellows 13 while allowing them to rotate relative to one another. In preferred embodiments, components 20A and 20B are integral, co-molded lips formed on the bellows front 21 and base 14, respectively.

Located within the bellows 13 is a clip 10. Clip 10 features a pair of jaws 16 which are sized so as to be able to clamp onto the louvers of a vehicle's air vent. The space between the two jaws defines a jaw opening, and a plurality of teeth are preferably disposed on the mutually-facing surfaces of the two jaws. The teeth provide the jaws with an effectively firm grip on the louvers of the vehicle vent. In alternative embodiments, a layer of foam or elastomer having sufficiently high friction when pressed against the louvers of the vehicle vent may serve the same purpose.

Opposite the jaws 16, clip 10 features a first element of a multi-axis rotatable joint, preferably a socket component 24 of a ball joint as shown in the illustrated embodiment. Socket component 24 clamps onto the ball of a ball joint (not shown; see FIG. 6). The ball, in this embodiment, is attached to the interior of base 14, but in alternative embodiments it may be attached to the interior of bellows 13. Adjustment of the ball joint, combined with rotation about the rotatable connector, serves to align the bellows with the vehicle's air vent, and to orient the base 14 at a desired angle.

The jaws 16 of clip 10 may be attached to one of the horizontal or vertical louvers of a vehicle air vent. To attach the holder of the invention, the jaw opening is positioned against the outer edge of the vehicle louver. The holder is then pressed against the louver until the louver has been forced into the jaw opening. The plurality of teeth prevents the louver from slipping out from between the jaws. In alternative embodiments, this retention function may be performed by the friction provided by a layer of foam or elastomer. As seen in perspective views of the present invention, the jaw components of the present invention can be two shaped parallel plates. The plurality of teeth are small protuberances extending from the inner faces of the jaws. To ease installation, the plurality of teeth are preferably positioned so that at least some of the teeth meet crest-to-crest, so that the teeth of one jaw do not protrude beyond the teeth of the other.

In the illustrated embodiment, the clip 10 is attached to the base 14 via a ball-and-socket type of adjustable joint. The socket 24 is a spherical shell with an opening opposite from the jaws and jaw opening. The socket is shaped and dimensioned in order to snugly fit over the ball component of the ball-and-socket joint with an effective grip. “Effective grip” is defined as a gripping force sufficient to hold the joint fixed under the influence of environmental forces such as the weight of the holder and the held object, and the various accelerations normally experienced by a vehicle in motion, while at the same time allowing the joint to rotate when a user applies force by hand.

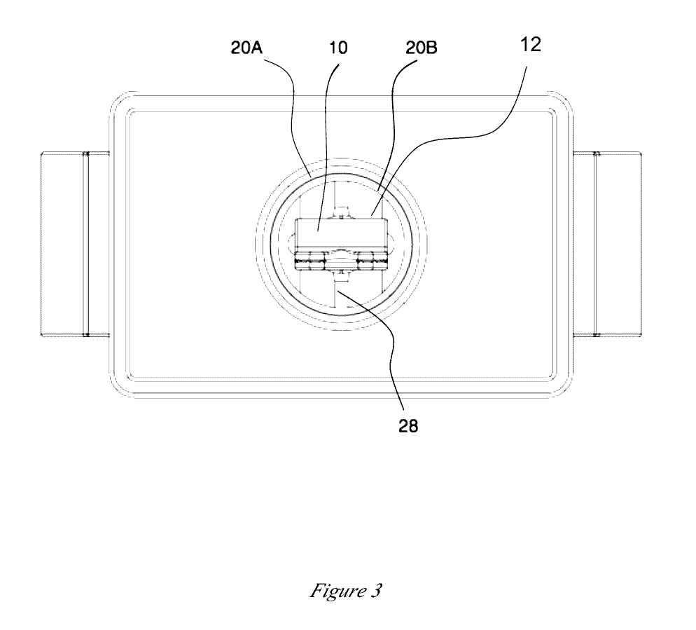

Turning to FIG. 3, in this particular embodiment, the ball component of the ball-and-socket joint is attached to the base via a mounting pillar 28. Preferably, the ball and pillar are integral with and co-molded with the base 14. Alternatively, the ball component may be attached to the bellows 13 rather than to the base 14. In alternative, equivalent embodiments, the locations of the ball and socket may be exchanged. In the preferred embodiments of the present invention, the bellows 13 is sized and dimensioned to encompass the entirety of a typical vehicle's air vent. Differently-sized bellows may be made available, so as to provide a fit with a majority of vehicle makes and models. In the embodiment shown, the nested cylindrical components 20A and 20B define a passage 12 through which air emerging from the vehicle vent can freely pass to the interior of base 14. When the bellows encases the vehicle's vent, air emerging from the vent is guided to flow through the passage 12, with little or no air leaking around the edges of the bellows.

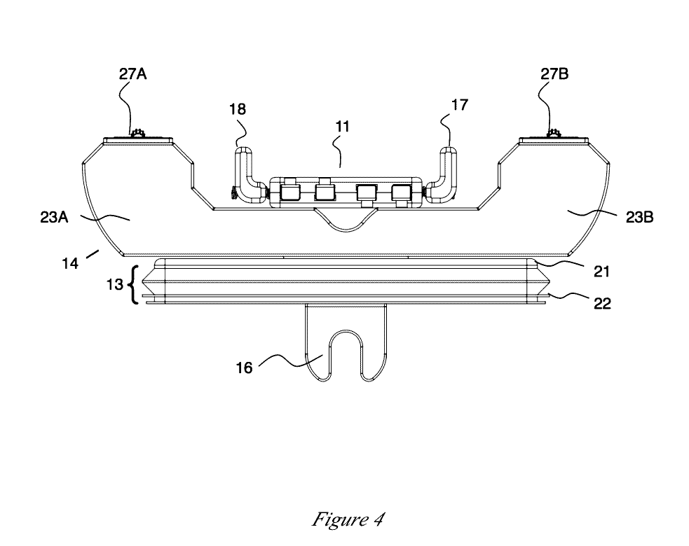

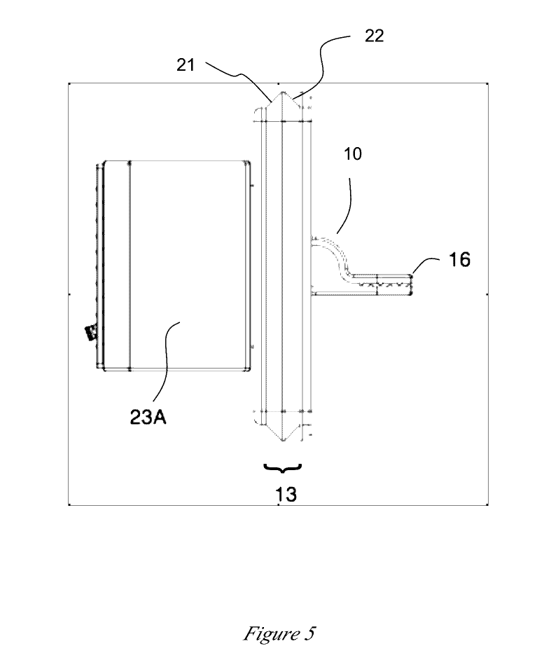

Turning to FIGS. 4 and 5, bellows 13 is seen to comprise a bellows back 22 and a bellows front 21. When the jaws 16 are attached to a louver of a vehicle's vent, the bellows back 22 is facing towards the vent, and the bellows front is directly adjacent to the back face of the base 14. In alternative embodiments of the present invention, the bellows may be adjustable for different sized vents. The bellows front 21 and bellows back 22 may each be formed from a rigid plastic, such as ABS or polystyrene, or they may be formed from an elastomer such as plasticized PVC, SBR, silicone rubber, or the like. Bellows back 22 is particularly suitable for elastomeric construction, in order to better conform to the shape of the vehicle dashboard surrounding the vehicle's air vents. In yet another embodiment of the present invention, interchangeable bellows of various sizes and shapes may be provided to fit various automobile vent sizes. As well, other similar devices may replace the bellows component, so long as the scope and objective of the present invention remains unchanged.

In preferred embodiments of the present invention, the base 14 is a hollow structure which, for aesthetic purposes, may have any of a variety of exterior contours. The base, in the illustrated embodiment, comprises two air-conducting ducts 23A and 23B. The interiors of these ducts are contiguous with passage 12, and serve as a path for air to flow from opening 12 to louvers 27A and 27B, respectively. The louvers function similarly to standard automobile vents, in that they provide for multi-directional air flow (up, down, left, and right), along with a closed or “off” orientation.

FIG. 6 is a cross-section through the view of FIG. 1, and illustrates the ball and socket joint comprising socket 24 and ball 25, as well as the four springs 19A-19D that serve to bias the clamp 11 toward a closed configuration.

When the present invention is clipped to an automobile's air vent and the user's phone is gripped by the clamp, the user may activate the automobile's climate control to turn on its fans, sending air of the desired temperature through the vent. The air is directed through the bellows and divided between duct portions 23A and 23B. The user may rotate the base to provide a horizontal or vertical orientation of the phone, and then control the mechanical angle of louvers 27A and 27B to establish a comfortable environment.

The invention is not limited to the preferred embodiments, examples, and drawings provided herein. It is to be understood that modifications and variations can be made, and equivalent structures and elements employed, without departing from the spirit and scope of the invention.

I claim:

1. A detachable holder for holding objects in place in a vehicle, comprising:
a. a means for attaching the holder to a louver of an air vent in the vehicle;
b. a substantially hollow body, linked to the means for attaching the holder by a multi-axis rotatable joint and having one or more air exit vents;
c. a bellows rotatably attached to the substantially hollow body and capable of substantially or completely covering the vehicle air vent; and
d. a clamp capable of holding the object to be held, attached to the substantially hollow body;
wherein an air passage is present between the bellows and the substantially hollow body, whereby air emerging from the vehicle's air vent is able to pass into the substantially hollow body and to exit the substantially hollow body through the one or more air exit vents.

2. The detachable holder of claim 1, wherein the multi-axis rotatable joint is a ball-and-socket joint.

3. The detachable holder of claim 1, wherein the bellows is rotatably connected to the body by nested cylindrical connectors.

4. The detachable holder of claim 3, wherein the multi-axis rotatable joint projects through a cylindrical space defined by the cylindrical connectors, and lies on the axis thereof.

5. A detachable holder for holding objects in place in a vehicle, comprising:
a. a means for attaching the holder to a louver of an air vent in the vehicle;
b. a bellows, linked to the means for attaching by a multi-axis rotatable joint and capable of substantially or completely covering the vehicle air vent;
c. a substantially hollow body, having one or more air exit vents, rotatably attached to the bellows; and
d. a clamp capable of holding the object to be held, attached to the substantially hollow body;
wherein an air passage is present between the bellows and the substantially hollow body, whereby air emerging from the vehicle's air vent is able to pass into the substantially hollow body and to exit the substantially hollow body through the one or more air exit vents.

6. The detachable holder of claim 9, wherein the multi-axis rotatable joint is a ball-and-socket joint.

7. The detachable holder of claim 9, wherein the bellows is rotatably connected to the body by nested cylindrical connectors.

8. The detachable holder of claim 1, having two air exit vents.

9. The detachable holder of claim 2, having two air exit vents.

10. The detachable holder of claim 3, having two air exit vents.

11. The detachable holder of claim 4, having two air exit vents.

12. The detachable holder of claim 5, having two air exit vents.

13. The detachable holder of claim 6, having two air exit vents.

14. The detachable holder of claim 7, having two air exit vents.

15. The detachable holder of claim 1, wherein the clamp is capable of holding a cell phone.

16. The detachable holder of claim 2, wherein the clamp is capable of holding a cell phone.

17. The detachable holder of claim 3, wherein the clamp is capable of holding a cell phone.

18. The detachable holder of claim 4, wherein the clamp is capable of holding a cell phone.

19. The detachable holder of claim 5, wherein the clamp is capable of holding a cell phone.

20. The detachable holder of claim 6, wherein the clamp is capable of holding a cell phone.

21. The detachable holder of claim 7, wherein the clamp is capable of holding a cell phone.

22. The detachable holder of claim 8, wherein the clamp is capable of holding a cell phone.

23. The detachable holder of claim 12, wherein the clamp is capable of holding a cell phone.
